(19) United States
(12) Patent Application Publication
(10) Pub. No.: US 2018/0043301 A1
(43) Pub. Date: Feb. 15, 2018

(54) HYGROSCOPIC MATERIAL, METHOD FOR PRODUCING THE SAME, AND PACKAGING MATERIAL

(71) Applicant: FUJIFILM CORPORATION, Tokyo (JP)

(72) Inventors: Toshihiro NAKATANI, Shizuoka (JP); Shin OZAWA, Shizuoka (JP); Ryuta TAKEGAMI, Shizuoka (JP); Takao ASAKURA, Shizuoka (JP)

(21) Appl. No.: 15/791,427

(22) Filed: Oct. 24, 2017

Related U.S. Application Data
(63) Continuation of application No. PCT/JP2016/061316, filed on Apr. 6, 2016.

(30) Foreign Application Priority Data
May 1, 2015 (JP) 2015-094269

(51) Int. Cl. B01D 53/28; B01J 20/26; B65D 81/26; B01J 20/04; B65D 65/16; B32B 27/30; B01J 20/28

(52) U.S. Cl. CPC B01D 53/28; B32B 27/306; B01J 20/261; B01J 20/28035; B01J 20/046; B65D 65/16; B65D 81/264; B01D 2253/202; B01D 2253/206; B01D 2253/10; B32B 2307/412

(57) ABSTRACT

Provided are a hygroscopic material having a transparent base material, a upper layer including a vinyl acetate resin, and a hygroscopic layer which is arranged between the base material and the upper layer to be adjacent to the upper layer and includes a moisture-absorbing agent which is an inorganic salt, and a resin, a method for producing the same, and a packaging material.

### CROSS-REFERENCE TO RELATED APPLICATION

This application is a continuation application of International Application No. PCT/JP2016/061316, filed Apr. 6, 2016, the disclosure of which is incorporated herein by reference in its entirety. Further, this application claims priority from Japanese Patent Application No. 2015-094269, filed May 1, 2015, the disclosure of which is incorporated herein by reference in its entirety.

### BACKGROUND OF THE INVENTION

### 1. Field of the Invention

The present invention relates to a hygroscopic material, a method for producing the same, and a packaging material.

### 2. Description of the Related Art

For products which are easily affected by humidity, such as pharmaceutical products and electronic components, it is required to keep the humidity of a storage area low. Therefore, in a case of packaging pharmaceutical products, electronic components, and the like, a drying agent such as silica gel is usually enclosed together with the products. Although the enclosure of a drying agent is typically automatically performed, a packaging step is complicated and packaging is sometimes manually carried out depending on the product. Thus, the operation is troublesome. In addition, for pharmaceutical products, electronic components, and the like, the cost of failing to remember to put in a drying agent is considerable. In recent years, instead of the enclosure of a drying agent, there has been a proposal to use a hygroscopic material (for example, a hygroscopic film) as a packaging material.

The hygroscopic materials known are as follows.

For example, as a high moisture absorbing and releasing material which has high hygroscopicity, a high moisture absorbing rate, and moisture absorbing and releasing properties, a high moisture absorbing and releasing material in which a metal ion is included in a polar polymer in a colloidal state is known (for example, refer to JP1991-188922A (JP-H03-188922A)).

There is known a hygroscopic material including a hygroscopic polymer layer, a hygroscopic layer having a porous structure including amorphous silica having an average secondary particle diameter of 10 μm or less, a water-soluble resin, and a moisture-absorbing agent, and a moistureproof layer in this order, as a hygroscopic material having a large moisture absorption capacity and high transparency, and capable of controlling a moisture absorbing rate by constitutional materials (for example, refer to JP2014-237121A).

### SUMMARY OF THE INVENTION

However, it is required for packaging materials for pharmaceutical products, electronic components, and the like to have transparency in addition to hygroscopicity so that the content is visible in terms of quality control.

Regarding this point, in the high moisture absorbing and releasing material disclosed in JP1991-188922A (JP-H03-188922A), a moisture-absorbing agent having a large moisture absorption capacity such as calcium chloride is used. Thus, while the material has high hygroscopicity, the surface has pressure sensitive adhesiveness and foreign substances easily adhere to the material. Therefore, light scattering occurs due to the adhering foreign substances, and thus causes a problem of deterioration in transparency. In order to prevent foreign substances from adhering, a method for providing a new layer on the surface having pressure sensitive adhesiveness is considered. However, when the present inventors have conducted investigations, it has been found that in a case of simply providing a new layer on the pressure sensitive adhesive surface of the hygroscopic layer including a moisture-absorbing agent such as calcium chloride, aggregates are easily generated between the hygroscopic layer and the new layer and light scattering occurs due to the generation of the aggregates, thereby deteriorating transparency.

In addition, while the hygroscopic material disclosed in JP2014-237121A has both hygroscopicity and transparency, there is room for further improvement in transparency.

One embodiment of the present invention has been made in view of the above-described circumstances and an object thereof is to achieve the following object.

That is, an object of one embodiment of the present invention is to provide a hygroscopic material having both excellent hygroscopicity and excellent transparency, a method for producing the same, and a packaging material.

Specific means for solving the above-described problem include the following aspects.

<1> A hygroscopic material comprising: a transparent base material; an upper layer including a vinyl acetate resin; and a hygroscopic layer which is arranged between the base material and the upper layer to be adjacent to the upper layer and includes a moisture-absorbing agent which is an inorganic salt, and a resin.

<2> The hygroscopic material according to <1>, in which a total light transmittance is 85% or more, and a haze is 30% or less.

<3> The hygroscopic material according to <1> or <2>, in which an amount of moisture absorption is 1 g/m² or more.

<4> The hygroscopic material according to any one of <1> to <3>, in which the resin included in the hygroscopic layer is a water-soluble resin.

<5> The hygroscopic material according to <4>, in which the water-soluble resin is a polyvinyl alcohol resin.

<6> The hygroscopic material according to any one of <1> to <5>, in which the moisture-absorbing agent is calcium chloride.

<7> The hygroscopic material according to any one of <1> to <6>, in which the upper layer includes particles of the vinyl acetate resin.

<8> The hygroscopic material according to <7>, in which the particles of the vinyl acetate resin have a volume average particle diameter of from 0.01 μm to 10 μm.

<9> The hygroscopic material according to any one of <1> to <7>, in which the vinyl acetate resin included in the upper layer is a copolymer including at least a constitutional unit derived from a vinyl acetate monomer and a constitutional unit derived from a vinyl chloride monomer.

<10> The hygroscopic material according to <9>, in which the copolymer is at least one selected from the group consisting of vinyl chloride/vinyl acetate copolymer and ethylene/vinyl chloride/vinyl acetate copolymer.

<11> The hygroscopic material according to any one of <1> to <10>, in which the upper layer has a thickness of from 0.1 μm to 10 μm.

<12> A packaging material comprising: the hygroscopic material according to any one of <1> to <11>,

<13> A method for producing the hygroscopic material according to any one of <1> to <11>, the method comprising: an arrangement step of arranging a hygroscopic layer including a moisture-absorbing agent which is an inorganic salt, and a resin, and an upper layer including a vinyl acetate resin on a transparent base material.

<14> The method for producing a hygroscopic material according to <13>, in which the arrangement step includes a hygroscopic layer forming step of forming the hygroscopic layer by applying a hygroscopic layer forming coating liquid including a moisture-absorbing agent which is an inorganic salt, and a resin to the transparent base material, and an upper layer forming step of forming the upper layer by applying an upper layer forming coating liquid including particles of vinyl acetate resin to the transparent base material.

According to one embodiment of the present invention, a hygroscopic material having both excellent hygroscopicity and excellent transparency, a method for producing the same, and a packaging material are provided.

### BRIEF DESCRIPTION OF THE DRAWING

FIG. 1 is a schematic cross-sectional view showing an example of a laminated structure of a hygroscopic material of the present disclosure.

### DESCRIPTION OF THE PREFERRED EMBODIMENTS

Hereinafter, specific embodiments of the present invention will be described in detail. However, the present invention is not limited to the following embodiments at all and may be performed under proper modifications within the scope of the object of the present invention.

In the specification, the range of a numerical value denoted by using “to” means a range including the numerical values set before and after “to” as the minimum value and the maximum value, respectively.

Unless otherwise specified, the amount of each component in a composition in the specification means a total amount of a plurality of substances existing in the composition in a case in which the plurality of substances corresponding to each component exists in the composition.

The term “step” in the specification does not only refer to an independent step, and other steps in a case in which there is no clear distinction between the step and the other steps are also included in this term as long as expected purposes of the steps are achieved.

[Hygroscopic Material]

A hygroscopic material of the present disclosure is a hygroscopic material including a transparent base material (hereinafter, also simply referred to as “base material”), an upper layer including a vinyl acetate resin, and a hygroscopic layer which is arranged between the base material and the upper layer to be adjacent to the upper layer and includes a moisture-absorbing agent which is an inorganic salt, and a resin.

The hygroscopic material of the present disclosure has both excellent hygroscopicity and excellent transparency.

In the hygroscopic material of the related art, a moisture-absorbing agent having a large moisture absorption capacity such as calcium chloride is used in order to improve moisture absorbability. Therefore, while the material has high hygroscopicity, the surface has pressure sensitive adhesiveness, and thus foreign substances easily adhere. In a case in which foreign substances easily adhere to the hygroscopic material, light scattering easily occurs due to the adhering foreign substances, and thus the transparency of the hygroscopic material is deteriorated. It is considered that foreign substances are prevented from adhering by providing a new layer on the surface having pressure sensitive adhesiveness. However, in a case of simply providing a new layer, aggregates are easily generated between the surface having pressure sensitive adhesiveness and the new layer and light scattering occurs due to the generated aggregates, thereby deteriorating transparency. Therefore, in the hygroscopic material of the related art, it is difficult to obtain both excellent hygroscopicity and excellent transparency.

On the other hand, the hygroscopic material of the present disclosure includes a transparent base material, an upper layer including a vinyl acetate resin, and a hygroscopic layer which is arranged between the base material and the upper layer to be adjacent to the upper layer and includes a moisture-absorbing agent which is an inorganic salt, and a resin. Thus, both excellent hygroscopicity and excellent transparency can be realized. That is, in the hygroscopic material of the present disclosure, aggregates which may be generated between the hygroscopic layer and the upper layer can be suppressed by selecting a vinyl acetate resin as the material forming the upper layer adjacent to the hygroscopic layer including a moisture-absorbing agent which is an inorganic salt, and a resin. As a result, the transparency is maintained, and thus it is considered that a hygroscopic material having both excellent hygroscopicity and excellent transparency can be realized compared to the hygroscopic material of the related art.

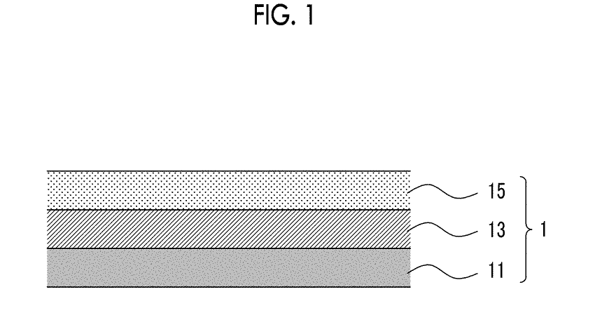

FIG. 1 is a schematic cross-sectional view showing an example of a laminated structure of the hygroscopic material of the present disclosure.

For example, as shown in FIG. 1, the hygroscopic material of the present disclosure may be a hygroscopic material 1 including a base material 11, a hygroscopic layer 13 which is laminated on the base material 11, and an upper layer 15 which is laminated on the hygroscopic layer 13, and may include layers other than the base material, the hygroscopic layer, and the upper layer within the range not impairing the effect of the present invention.

Hereinafter, each layer forming the hygroscopic material of the present disclosure will be described in detail.

<Base Material>

The hygroscopic material of the present disclosure has a transparent base material.

The term “transparent base material” in the specification refers to a base material of which the total light transmittance is 85% or more and the haze is 30% or less, and preferably refers to a base material of which the total light transmittance is 90% or more and the haze is 25% or less.

The total light transmittance of the base material is a value measured according to JIS K7361-1:1997. In addition, the haze of the base material is a value measured according to JIS K7136:2000. Specifically, the total light transmittance and the haze of the base material are measured in an environment at an atmosphere temperature of 23° C. and a relative humidity of 50% using a haze meter (model number: NDH-5000, manufactured by Nippon Denshoku Industries Co., Ltd.) as a measurement apparatus.

The base material is not particularly limited as long as the base material satisfies the conditions of the total light transmittance and the haze. In general, the form of the base material is a film or a sheet.

Examples of the material forming the base material include resins such as polyesters [such as polyethylene terephthalate (PET), polyethylene naphthalate, or polybutylene terephthalate], polyethylenes [such as linear low density polyethylene (LLDPE), low density polyethylene (LDPE), or high density polyethylene (HDPE)], polypropylene (PP), polymethyl pentene, triacetyl cellulose, cellophane, rayon, polystyrene, polycarbonate, polyimide, polyamide, polyvinyl chloride (PVC), polyacrylonitrile (PAN), polyphenylene sulfide, polyetherimide, polyether sulfone, aromatic polyamide, polysulfone, and polyvinylidene chloride (PVDC).

Among these, as the material forming the base material, from the viewpoint of versatility, transparency, and moldability, at least one selected from polyethylene terephthalate (PET), polypropylene (PP), polyvinyl chloride (PVC), polyethylene (PE), and polystyrene (PS) is preferable and at least one selected from polyethylene terephthalate (PET), polypropylene (PP), and polyvinyl chloride (PVC) is more preferable.

In the present disclosure, as the base material, for example, a film or sheet formed using at least one of the materials by a known film forming method (such as a T-die method or an inflation method) may be used, or a commercially available product on the market may be used.

The base material may also be a uniaxially stretched film or biaxially stretched film, obtained by stretching a film which is formed using at least one of the above-mentioned materials.

The base material may also be a film having a laminated structure of two or more layers.

From the viewpoint of improving the adhesion of the base material with an adjacent layer, for example, a hygroscopic layer, which will be described below, a surface of the base material on which the hygroscopic layer is to be formed may be subjected to a surface treatment in advance. Examples of the surface treatment include known surface treatments such as a corona discharge treatment and an ozone treatment.

The thickness of the base material is preferably 20 μm or more and 400 μm or less, more preferably 30 μm or more and 350 μm or less, and even more preferably 40 μm or more and 300 μm or less from the viewpoint of handleability, handleability in a case in which a hygroscopic material is formed, and transparency.

<Hygroscopic Layer>

The hygroscopic material of the present disclosure has a hygroscopic layer including a moisture-absorbing agent which is an inorganic salt.

In the hygroscopic material of the present disclosure, the hygroscopic layer is positioned between the above-described base material and the upper layer which will be described later and is adjacent to the upper layer.

(Moisture-Absorbing Agent)

The hygroscopic layer includes at least one moisture-absorbing agent which is an inorganic salt.

Examples of the moisture-absorbing agent which is an inorganic salt, include halogenated metal salts such as lithium chloride, calcium chloride, magnesium chloride, and aluminum chloride, metal sulfates such as sodium sulfate, calcium sulfate, magnesium sulfate, and zinc sulfate, potassium hydroxide, sodium hydroxide, and magnesium hydroxide.

Among these, as the moisture-absorbing agent which is an inorganic salt, at least one selected from halogenated metal salts and metal sulfates is preferable, at least one selected from halogenated metal salts is more preferable, and calcium chloride is particularly preferable from the viewpoint of moisture absorption capacity and transparency in a case in which a hygroscopic material is formed.

The content of the moisture-absorbing agent which is an inorganic salt, in the hygroscopic layer is preferably 1% by mass or more and 80% by mass or less, more preferably 5% by mass or more and 70% by mass or less, and even more preferably 10% by mass or more and 60% by mass or less with respect to the total solid content in the hygroscopic layer from the viewpoint of obtaining both further excellent hygroscopicity and further excellent transparency.

The content of the moisture-absorbing agent which is an inorganic salt, in the hygroscopic layer is preferably 1 g/m² or more and 40 g/m² or less, more preferably 2 g/m² or more and 35 g/m² or less, and even more preferably 3 g/m² or more and 30 g/m² or less from the viewpoint of obtaining both further excellent hygroscopicity and further excellent transparency.

(Resin)

The hygroscopic layer includes at least one resin.

In the hygroscopic layer, a resin functions as a binder.

The resin is not particularly limited. For example, the resin can be widely selected and used from water-soluble resins and water-insoluble resins.

As the resin included in the hygroscopic layer, from the viewpoint of transparency, a water-soluble resin is preferable.

The term “water-soluble resin” in the specification refers to a resin of which the dissolution amount with respect to 100 g of water at 20° C. is 0.05 g or more and preferably refers to a resin of which the dissolution amount with respect to 100 g of water at 20° C. is 0.1 g or more.

Examples of the water-soluble resin include resins having a hydroxy group as a hydrophilic structure unit, such as polyvinyl alcohol resins [polyvinyl alcohol (PVA), acetoacetyl modified polyvinyl alcohol, cation modified polyvinyl alcohol, anion modified polyvinyl alcohol, silanol modified polyvinyl alcohol, and polyvinylacetal], cellulose resins [such as methyl cellulose (MC), ethyl cellulose (EC), hydroxyethyl cellulose (HEC), carboxymethyl cellulose (CMC), hydroxypropyl cellulose (HPC), hydroxyethyl methyl cellulose, and hydroxypropyl methyl cellulose], ether bond-containing resins [such as polypropylene oxide (PPO), polyethylene glycol (PEG), and polyvinyl ether (PVE)], and carbamoyl group-containing resins [such as polyacrylamide (PAAM), polyvinylpyrrolidone (PVP) and polyacrylic acid hydrazide]. Polyacrylic acid (PAA) or a salt thereof having a carboxylic group as a dissociating group, maleic acid resins, and gelatins are also included in the examples of the water-soluble resin. Further, specific examples of the water-soluble resin mentioned above are also included in the water-soluble resin.

Among these, as the water-soluble resin, from the viewpoint of the transparency of the hygroscopic layer, at least one selected from polyacrylic acid and polyvinyl alcohol resins is preferable, and polyvinyl alcohol is particularly preferable.

In a case in which the resin included in the hygroscopic layer is a polyvinyl alcohol resin, the degree of saponification of the polyvinyl alcohol resin is preferably 99% or less, more preferably 96% or less, and even more preferably 90% or less. In addition, the degree of saponification of the polyvinyl alcohol resin is preferably 70% or more, more preferably 78% or more, and even more preferably 85% or more. In a case of a degree of saponification of 70% or more, it is possible to practically maintain water solubility.

The content of the resin in the hygroscopic layer is preferably 20% by mass or more, more preferably 30% by mass or more, and even more preferably 40% by mass or more with respect to the total solid content of the hygroscopic layer from the viewpoint of preventing transparency and film hardness from being lowered. In addition, the content of the resin in the hygroscopic layer is preferably 99% by mass or less, more preferably 95% by mass or less, and even more preferably 90% by mass or less with respect to the total solid content of the hygroscopic layer.

The content of the resin in the hygroscopic layer is preferably 0.25 times or more, more preferably 0.5 times or more, and even more preferably 1 time or more than the content of the moisture-absorbing agent which is an inorganic salt, included in the hygroscopic layer, by mass, from the viewpoint of preventing transparency and film hardness from being lowered. Further, the content of the resin in the hygroscopic layer is preferably 99 times or less, more preferably 17 times or less, even more preferably 9 times or less than the content of the moisture-absorbing agent which is an inorganic salt, included in the hygroscopic layer, by mass.

If necessary, the hygroscopic layer may include components other than the moisture-absorbing agent which is an inorganic salt, and the resin, such as a surfactant, within the range not impairing the effect of the present invention.

The surfactant is not particularly limited and can be appropriately selected and used from known surfactants. As the surfactant, a compound that has a structure having both a hydrophilic portion and a hydrophobic portion in the molecule and the like can be used and any of anionic surfactants, cationic surfactants, amphoteric surfactants, nonionic surfactants, and betaine-based surfactants can be used. Among these, as the surfactant, from the viewpoint of the compatibility of the moisture-absorbing agent and the resin, a nonionic surfactant such as polyoxyethylene alkyl ether (for example, polyoxyethylene lauryl ether) is preferable.

˜Thickness of Hygroscopic Layer˜

The thickness of the hygroscopic layer is not particularly limited.

For example, the thickness of the hygroscopic layer is preferably 2 μm or more and 50 μm or less, more preferably 5 μm or more and 45 μm or less, even more preferably 10 or more and 40 μm or less from the viewpoint of obtaining both further excellent hygroscopicity and further excellent transparency.

<Upper Layer>

The hygroscopic material of the present disclosure has an upper layer including at least one vinyl acetate resin.

The term “vinyl acetate resin” in the specification is a general term for polymers including vinyl acetate as a monomer unit. Examples of the vinyl acetate resin include a vinyl acetate resin including vinyl acetate as monomer units, and a copolymer of vinyl acetate and another monomer. Here, another monomer includes ethylene, vinyl chloride, and acrylic monomers. In addition, the copolymer of vinyl acetate and another monomer may be a multicomponent copolymer such as a binary copolymer and a ternary copolymer.

Specific examples of the vinyl acetate resin include polyvinyl acetate, ethylene/vinyl acetate copolymer, ethylene/vinyl chloride/vinyl acetate copolymer, vinyl chloride/vinyl acetate copolymer, and acrylic ester/vinyl acetate copolymer.

Among these, from the viewpoint of transparency, at least a copolymer having a constitutional unit derived from a vinyl acetate polymer and a constitutional unit derived from a vinyl chloride polymer, specifically, the vinyl acetate resin is preferably at least one selected from vinyl chloride/vinyl acetate copolymer and ethylene/vinyl chloride/vinyl acetate copolymer.

In a case in which the vinyl acetate resin is a copolymer of vinyl acetate and another monomer, the ratio of the constitutional unit derived from the vinyl acetate monomer in the copolymer is preferably 1% by mole or more and 100% by mole or less, more preferably 5% by mole or more and 80% by mole or less, and even more preferably 10% by mole or more and 60% by mole or less with respect to 100% by mole of the total constitutional units forming the copolymer.

It is preferable that the vinyl acetate resin included in the upper layer is in the form of particles. The vinyl acetate resin included in the upper layer being in the form of particles can be confirmed by, for example, observation of an optical microscope.

The volume average particle diameter of the particles of the vinyl acetate resin included in the upper layer is preferably 0.01 μm to 10 μm, more preferably 0.05 μm to 5 μm, and even more preferably 0.1 μm to 3 μm.

The volume average particle diameter of the particles of the vinyl acetate resin is measured by a light scattering method using a particle size distribution measurement apparatus (LA-910, manufactured by Horiba, Ltd.) as a measurement apparatus.

As the vinyl acetate resin, a commercially available product on the market may be used. Examples of the commercially available product on the market include series of vinyl acetate-based emulsions of VINYBLAN (registered trademark) (manufactured by Nissin Chemical Co., Ltd.), and series of ethylene/vinyl acetate copolymer resin emulsions of SUMIKAFLEX (registered trademark) (manufactured by Sumika Chemtex Co., Ltd.).

The content of the vinyl acetate resin in the upper layer is preferably 30% by mass or more, more preferably 40% by mass or more, and even more preferably 50% by mass or more with respect to the total solid content of the upper layer from the viewpoint of transparency and film hardness. The content of the vinyl acetate resin in the upper layer is preferably 100% by mass or less, more preferably 99.9% by mass or less, and even more preferably 99.8% by mass or less with respect to the total solid content of the upper layer.

If necessary, the upper layer may include components other than the vinyl acetate resin, such as a surfactant, within the range not impairing the effect of the present invention.

The surfactant is not particularly limited and can be appropriately selected and used from known surfactants. As the surfactant, a compound that has a structure having both a hydrophilic portion and a hydrophobic portion in the molecule and the like can be used and any of anionic surfactants, cationic surfactants, amphoteric surfactants, nonionic surfactants, and betaine-based surfactants can be used. Among these, as the surfactant, a nonionic surfactant such as polyoxyethylene alkyl ether (for example, polyoxyethylene lauryl ether) is preferable.

˜Thickness of Upper Layer˜

It is preferable that the thickness of the upper layer is small in a range in which the hygroscopic layer can be protected from adhesion of foreign substances. For example, the thickness of the upper layer is preferably 0.1 μm or more and 10 μm or less, more preferably 0.3 μm or more and 8 μm or less, and even more preferably 0.5 μm or more and 6 μm or less. In a case in which the thickness of the upper layer is in the above range, it is possible to satisfactorily maintain the excellent transparency of the hygroscopic material.

[Thickness of Hygroscopic Material]

The thickness of the hygroscopic material of the present disclosure is preferably 20 or more and 500 μm or less, more preferably 35 μm or more and 450 μm or less, and even more preferably 50 μm or more and 400 μm or less from the viewpoint of transparency and handleability.

[Physical Properties of Hygroscopic Material]

The total light transmittance of the hygroscopic material of the present disclosure is preferably 85% or more, more preferably 89% or more, even more preferably 90% or more, and particularly preferably 92% or more.

The upper limit of the total light transmittance of the hygroscopic material of the present disclosure is not particularly limited and is, for example, 98% or less.

The haze of the hygroscopic material of the present disclosure is preferably 30% or less, more preferably 25% or less, and even more preferably 20% or less.

The lower limit of the haze of the hygroscopic material of the present disclosure is not particularly limited and is, for example, 1.0% or more.

It is preferable that the total light transmittance of the hygroscopic material of the present disclosure is 85% or more and the haze is 30% or less, it is more preferable that the total light transmittance is 89% or more and the haze is 25% or less, it is even more preferable that the total light transmittance is 90% or more and the haze is 20% or less, and it is particularly preferable that the total light transmittance is 92% or more and the haze is 20% or less.

The total light transmittance of the hygroscopic material of the present disclosure is a value measured according to JIS K7361-1:1997.

The haze of the hygroscopic material of the present disclosure is a value measured according to JIS K7136:2000. Specifically, the total light transmittance and the haze of the hygroscopic material of the present disclosure are measured in an environment at an atmosphere temperature of 23° C. and a relative humidity of 50% using a haze meter (model number: NDH-5000, manufactured by Nippon Denshoku Industries Co., Ltd.) as a measurement apparatus.

<Amount of Moisture Absorption>

The amount of moisture absorption of the hygroscopic material of the present disclosure is preferably 1 g/m² or more, more preferably 2 g/m² or more, and even more preferably 3 g/m² or more.

The upper limit of the amount of moisture absorption of the hygroscopic material of the present disclosure is not particularly limited and is, for example, 15 g/m² or less.

The amount of moisture absorption of the hygroscopic material of the present disclosure is measured by the following method.

The hygroscopic material is cut into a size of 100 mm×100 mm to obtain a sample for evaluation. The sample for evaluation is stored in a thermohygrostat bath set at a temperature of 60° C. and a relative humidity of 10% for 1 day and dried. Next, the sample for evaluation after being dried is moved to an environment at a temperature of 23° C. and a relative humidity of 50%, and then the mass thereof immediately after the sample is moved (within 20 seconds) is measured. Then, the obtained measurement value is set to the mass of the sample for evaluation in a dried state. Thereafter, a change in mass of the sample for evaluation along with the lapse of time is measured and the mass at the time when a change in mass does not occur is set to the mass of the sample for evaluation in a saturated state. The amount of moisture absorption of the sample for evaluation (unit: g/m²) is obtained by subtracting the mass in a dried state from the mass in a saturated state and is set to the amount of moisture absorption of the hygroscopic material of the present disclosure.

[Method for Producing Hygroscopic Material]

A method for producing a hygroscopic material of the present disclosure is not particularly limited as long as the above-described hygroscopic material can be produced. The method for producing a hygroscopic material of the present disclosure is preferably a method for producing a hygroscopic material of an embodiment, which will be described below.

The method for producing a hygroscopic material of the embodiment (hereinafter, also referred to as “production method of the embodiment”) has an arrangement step of arranging a hygroscopic layer including a moisture-absorbing agent (hereinafter, also simply referred to as “moisture-absorbing agent”) which is an inorganic salt, and a resin, and an upper layer including a vinyl acetate resin on a transparent base material (hereinafter, also simply referred to as “base material”).

The production method of the embodiment may have other steps if necessary.

Hereinafter, the step of the production method of the embodiment will be described in detail.

Specific examples of components used in each step and preferable aspects are as described in the hygroscopic material section described above, and thus the descriptions thereof are omitted herein.

<Arrangement Step>

The arrangement step is a step of arranging a hygroscopic layer including a moisture-absorbing agent which is an inorganic salt, and a resin, and an upper layer including a vinyl acetate resin on a transparent base material.

As the method for arranging the hygroscopic layer and the upper layer on the base material, a coating method, a melt lamination method (for example, JP1995-199405A (JP-H07-199405A)), and the like may be used.

It is preferable that the arrangement step includes a hygroscopic layer forming step of forming the hygroscopic layer by applying a hygroscopic layer forming coating liquid including a moisture-absorbing agent which is an inorganic salt, and a resin to the transparent base material, and an upper layer forming step of forming the upper layer by applying an upper layer forming coating liquid including particles of vinyl acetate resin to the transparent base material from the viewpoint of obtaining a more satisfactory surface state.

<<Hygroscopic Layer Forming Step>>

The hygroscopic layer forming step is a step of forming a hygroscopic layer by applying a hygroscopic layer forming coating liquid including a moisture-absorbing agent which is an inorganic salt, and a resin to a transparent base material.

If necessary, the hygroscopic layer forming coating liquid may include components other than the moisture-absorbing agent and the resin, such as a solvent and a surfactant.

Examples of the solvent include water, an organic solvent and a mixture solvent thereof.

Examples of the organic solvent include alcohols such as methanol, ethanol, n-propanol, i-propanol, and methoxy propanol, ketones such as acetone, and methyl ethyl ketone, tetrahydrofuran, acetonitrile, ethyl acetate, and toluene. Among these, as the solvent, water is preferable from the viewpoint of environmental suitability.

The hygroscopic layer forming coating liquid can be prepared by mixing, for example, a moisture-absorbing agent and a resin, and if necessary, other components such as a solvent and a surfactant.

The contents of the moisture-absorbing agent and the resin in the hygroscopic layer forming coating liquid may be respectively adjusted such that the contents of the moisture-absorbing agent and the resin in the hygroscopic layer formed finally become the amounts described in the hygroscopic material section described above.

The content of the solvent in the hygroscopic layer forming coating liquid is not particularly limited and is selected to be appropriate according to the kind and amount of the component to be formulated in the hygroscopic layer forming coating liquid or the like.

In a case in which the hygroscopic layer forming coating liquid includes a surfactant, the content of the surfactant in the hygroscopic layer forming coating liquid is set to be appropriate according to the kind and amount of the component to be formulated in the hygroscopic layer forming coating liquid or the like.

Each component to be mixed may be mixed simply. All of the components may be mixed at once and each component may be mixed several times in a divided manner.

The mixing method is not particularly limited and for example, mixing by stirring may be used.

The method for applying the hygroscopic layer forming coating liquid is not particularly limited and known application methods such as a blade coater, an air-knife coater, a roll coater, a bar coater, a gravure coater, a reverse coater, and the like may be used.

Regarding the amount of the hygroscopic layer forming coating liquid coated, from the viewpoint of the moisture absorbability and the transparency of the hygroscopic layer, the amount of the moisture-absorbing agent applied is preferably 1 g/m² or more and 40 g/m² or less and more preferably 2 g/m² or more and 35 g/m² or less.

Regarding the amount of the hygroscopic layer forming coating liquid applied, from the viewpoint of the moisture absorbability of the hygroscopic layer, the mass after drying is preferably 2 g/m² or more and 50 g/m² or less and more preferably 5 g/m² or more and 45 g/m² or less.

After the hygroscopic layer forming coating liquid is applied to the base material, the coating film (hereinafter, also referred to as “first coating film”) is dried before the coating film exhibits falling rate drying.

The first coating film is generally dried at 40° C. to 180° C. for 1 minute to 60 minutes (preferably for 2 minutes to 30 minutes).

<<Upper Layer Forming Step>>

The upper layer forming step is a step of forming an upper layer forming by applying an upper layer forming coating liquid including particles of vinyl acetate resin to the transparent base material.

If necessary, the upper layer forming coating liquid may include components other than the particles of vinyl acetate resin, such as a solvent and a surfactant.

Examples of the solvent include water, an organic solvent and a mixture solvent thereof.

Examples of the organic solvent are the same as the examples of the organic solvent in the hygroscopic layer forming coating liquid described above. Among these, as the organic solvent, water is preferable from the viewpoint of environmental suitability.

It is preferable that the upper layer forming coating liquid is prepared using a water dispersion of particles of vinyl acetate resin (also referred to as “latex” or “emulsion”).

In a case in which the upper layer forming coating liquid is prepared using a water dispersion of the particles of vinyl acetate resin, the upper layer forming coating liquid and the hygroscopic layer forming coating liquid can be applied to the base material by simultaneous double-layer coating. According to the simultaneous double-layer coating, it is possible not only to improve the productivity of the hygroscopic material (the production time can be shortened and the production cost can be reduced) but also to prevent deterioration in the transparency of the hygroscopic material due to adhesion of foreign substances to the surface of the hygroscopic layer opposite to the upper layer after the hygroscopic layer is formed and before the upper layer is formed.

The water dispersion of the particles of vinyl acetate resin is preferably nonionic latex in which the surfaces of the vinyl acetate resin particles are not charged. In a case in which the water dispersion of the particles of vinyl acetate resin is nonionic latex and the upper layer forming coating liquid includes other components, the compatibility with other components is easily obtained.

The water dispersion of the particles of vinyl acetate resin can be obtained by mixing particles of vinyl acetate resin and water, and if necessary, a dispersing agent such as a surfactant, and performing a dispersion treatment.

The dispersion treatment method is not particularly limited and for example, a dispersion treatment using a disperser may be used.

As the disperser, various known dispersers such as a high speed rotary disperser, a medium stirring type disperser (such as a ball mill or a sand mill), an ultrasonic disperser, a colloid mill disperser, and a high pressure disperser can be used.

The upper layer forming coating liquid can be prepared by mixing, for example, particles of vinyl acetate resin and a solvent (preferably a water dispersion of particles of vinyl acetate resin), and if necessary, other components such as a dispersing agent (for example, a surfactant).

The content of the particles of vinyl acetate resin in the upper layer forming coating liquid may be adjusted such that the content of the vinyl acetate resin in the upper layer formed finally becomes the amount of the hygroscopic material section described above.

The content of the solvent in the upper layer forming coating liquid is not particularly limited and is selected to be appropriate according to the kind and the amount of the component to be formulated in the upper layer forming coating liquid or the like.

In a case in which the upper layer forming coating liquid includes a surfactant, the content of the surfactant in the upper layer forming coating liquid is set to be appropriate according to the kind and the amount of the component to be formulated in the upper layer forming coating liquid or the like.

The method for applying the upper layer forming coating liquid is not particularly limited and a method for simultaneously applying the upper layer forming coating liquid and the hygroscopic layer forming coating liquid may be used.

Regarding the amount of the upper layer forming coating liquid applied, from the viewpoint of transparency and protection of the hygroscopic layer, the mass after drying is preferably 0.1 g/m² or more and 10 g/m² or less and more preferably 0.3 g/m² or more and 8 g/m² or less.

After the upper layer forming coating liquid is applied to the base material, the coating film (hereinafter, also referred to as “second coating film”) is dried before the coating film exhibits falling rate drying.

The second coating film is generally dried at 40° C. to 180° C. for 1 minute to 30 minutes (preferably for 2 minutes to 20 minutes).

In the production method of the embodiment, after the hygroscopic layer forming step of forming the hygroscopic layer on the base material, the upper layer forming step of forming the upper layer on the hygroscopic layer formed on the base material may be performed, or the hygroscopic layer forming step and the upper layer forming step may be collectively performed by performing double-layer coating of simultaneously applying the hygroscopic layer forming coating liquid and the upper layer forming coating liquid to the base material (also referred to as “simultaneous double-layer coating”). According to the simultaneous double-layer coating, excellent productivity can be obtained since the number of application and drying processes is reduced.

The simultaneous double-layer coating can be performed by an application method using an extrusion die coater, a curtain flow coater, or the like.

After the simultaneous double-layer coating is performed, the formed coating films are dried. The coating films formed by the double-layer coating are dried generally at 40° C. to 180° C. for 1 minute to 60 minutes (preferably at 50° C. to 150° C. for 2 minutes to 30 minutes).

Since the coating films formed by the simultaneous double-layer coating are layered on each other in an undried liquid state, the coating liquids are more easily mixed between adjacent layers and interfacial disorder (unevenness or the like) is more easily generated.

From this viewpoint, in the case of simultaneous double-layer coating, the viscosity of each of the hygroscopic layer forming coating liquid and the upper layer forming coating liquid at 25° C. is preferably 0.3 mPa·s to 500 mPa·s, more preferably 0.5 mPa·s to 300 mPa·s, and even more preferably 1 mPa·s to 150 mPa·s.

The viscosity of each of the hygroscopic layer forming coating liquid and the upper layer forming coating liquid is a value measured using a viscometer (VISCOMETER TV-22, manufactured by Toki Sangyo Co., Ltd.).

The production method of the embodiment may have steps other than the arrangement step, if necessary. In addition, the arrangement step may have steps other than the hygroscopic layer forming step and the upper layer forming step.

Examples of other steps include a step of preparing a base material, and a step of subjecting the base material to a surface treatment.

<Packaging Material>

A packaging material of the present disclosure includes the hygroscopic material of the present disclosure described above.

The hygroscopic material of the present disclosure may be used alone as the packaging material and may be used as the packaging material by combining hygroscopic material and other materials (for example, aluminum seal) within the range not impairing the object of the present invention.

Since the hygroscopic material of the present disclosure has both excellent hygroscopicity and excellent transparency, the hygroscopic material is particularly suitably used as a packaging material or a material thereof for packaging a pharmaceutical product, an electronic component, and the like, for which a packaging material from which the content is visible is required to be used in terms of quality control, and the cost of failing to remember to put in a drying agent is considerable. The hygroscopic material of the present disclosure is also suitable for, for example, a material for a blister pack (also referred to as “PTP package”) used for packaging a pharmaceutical product.

### EXAMPLES

Hereinafter, the present invention will be more specifically described using examples. The present invention is not limited to the following examples as long as the present invention does not deviate from its gist.

The total light transmittance of the base material in each example was measured according to the method described in JIS standards (JIS K7361-1:1997). In addition, the haze of the base material in each example was measured according to the method described in JIS standards (JIS K7136:2000). Specifically, the total light transmittance and the haze of base material were measured in an environment at an atmosphere temperature of 23° C. and a relative humidity of 50% using a haze meter (model number: NDH-5000, manufactured by Nippon Denshoku Industries Co., Ltd.) as a measurement apparatus.

### Preparation of Hygroscopic Material

### Example 1

<Preparation of Base Material>

As a base material, a commercially available PET film (trade name: COSMO SHINE (registered trademark) A4300, thickness: 100 μm, manufactured by Toyobo Co., Ltd.) was used.

The total light transmittance and the haze of the base material were measured, and the total light transmittance and the haze were respectively 92.3% and 0.9%.

<Formation of Hygroscopic Layer>

(Preparation of Hygroscopic Layer Forming Coating Liquid) The following components were mixed to obtain a hygroscopic layer forming coating liquid.

—Composition of Hygroscopic Layer Forming Coating Liquid—

| | | |
|---|---|---|
| Calcium chloride (moisture-absorbing agent) | 3.0 | parts by mass |
| Polyvinyl alcohol (water-soluble resin) solution | 84.6 | parts by mass |
| Polyoxyethylene lauryl ether (surfactant) solution | 0.5 | parts by mass |
| Ion exchange water | 11.9 | parts by mass |

˜Polyvinyl Alcohol (Water-Soluble Resin) Solution˜

| | |
|---|---|
| Polyvinyl alcohol (PVA) | 20.0 parts by mass |
| (trade name: PVA403, average degree of | |
| polymerization: 300, degree of | |
| saponification: 78.5% to 81.5%, | |
| manufactured by Kuraray Co., Ltd.) | |
| Ion exchange water | 80.0 parts by mass |

˜Polyoxyethylene Lauryl Ether (Surfactant) Solution˜

| | |
|---|---|
| Polyoxyethylene lauryl ether | 10.0 parts by mass |
| (trade name: EMULGEN 109P, | |
| manufactured by KAO CORPORATION) | |
| Ion exchange water | 90.0 parts by mass |

(Formation of Hygroscopic Layer)

The hygroscopic layer forming coating liquid was applied to the corona discharge-treated surface of the obtained PET film of which one surface had been subjected to a corona discharge treatment by a bar coating method such that the mass after drying was 20 g/m² and thus, a coating film was formed. The formed coating film was dried in an environment at 60° C. for 20 minutes to form a hygroscopic layer having a thickness of about 20 μm.

<Formation of Upper Layer>

(Preparation of Upper Layer Forming Coating Liquid)

The following components were mixed to obtain an upper layer forming coating liquid.

—Composition of Upper Layer Forming Coating Liquid—

| | | |
|---|---|---|
| Ethylene/vinyl acetate copolymer (vinyl | 47.0 | parts by mass |
| acetate resin) (trade name: SUMIKAFLEX | | |
| (registered trademark) S-408HQE, | | |
| concentration of solid contents: 50% by mass, | | |
| manufactured by Sumika Chemtex Co., Ltd.) | | |
| Polyoxyethylene lauryl ether (surfactant) | 0.5 | parts by mass |
| solution | | |
| Ion exchange water | 52.5 | parts by mass |

˜Polyoxyethylene Lauryl Ether (Surfactant) Solution˜

| | |
|---|---|
| Polyoxyethylene lauryl ether | 10.0 parts by mass |
| (trade name: EMULGEN 109P, | |
| manufactured by KAO CORPORATION) | |
| Ion exchange water | 90.0 parts by mass |

(Formation of Upper Layer)

The upper layer forming coating liquid was applied to the surface of the hygroscopic layer formed on the base material as described above by a bar coating method such that the mass after drying was 2 g/m², and thus a coating film was formed. The formed coating film was dried in an environment at 60° C. for 3 minutes to form an upper layer having a thickness of about 2 μm.

In this manner, a hygroscopic material of Example 1 having a laminated structure of base material/hygroscopic layer/upper layer was prepared.

### Example 2

A hygroscopic material of Example 2 having a laminated structure of base material/hygroscopic layer/upper layer was prepared in the same manner as in Example 1 except that the base material in Example 1 was changed from the PET film to a polyvinyl chloride (PVC) film (thickness: 250 μm).

The total light transmittance and the haze of the base material of Example 2 were measured, and the total light transmittance and the haze were respectively 89.6% and 3.3%.

### Example 3

A hygroscopic material of Example 3 having a laminated structure of base material/hygroscopic layer/upper layer was prepared in the same manner as in Example 1 except that the base material in Example 1 was changed from the PET film to a lamination film of vinyl chloride/vinylidene chloride/vinyl chloride (PVC/PVDC/PVC) (thickness: 260 μm)

The total light transmittance and the haze of the base material of Example 3 were measured, and the total light transmittance and the haze were respectively 87.0% and 8.7%.

### Example 4

A hygroscopic material of Example 4 having a laminated structure of base material/hygroscopic layer/upper layer was prepared in the same manner as in Example 1 except that the base material in Example 1 was changed from the PET film to a non-axially stretched polypropylene film (CPP) film (thickness: 50 μm).

The total light transmittance and the haze of the base material of Example 4 were measured, and the total light transmittance and the haze were respectively 91.8% and 5.3%.

### Example 5

A hygroscopic material of Example 5 having a laminated structure of base material/hygroscopic layer/upper layer was prepared in the same manner as in Example 1 except that the resin in the hygroscopic layer forming coating liquid in Example 1 was changed from polyvinyl alcohol (PVA) to polyacrylic acid (PAA) (trade name: POLYACRYLIC ACID, weight-average molecular weight: 25,000, water-soluble resin, manufactured by Wako Pure Chemical Industries, Ltd.).

### Example 6

A hygroscopic material of Example 6 having a laminated structure of base material/hygroscopic layer/upper layer was prepared in the same manner as in Example 1 except that the resin in the hygroscopic layer forming coating liquid in Example 1 was changed from the polyvinyl alcohol solution to a dilution obtained diluting an ethylene/vinyl acetate copolymer (trade name: SUMIKAFLEX (registered trademark) S-408HQE, concentration of solid contents: 50% by mass, manufactured by manufactured by Sumika Chemtex Co., Ltd.) with ion exchange water at a ratio of 2/5.

### Example 7

A hygroscopic material of Example 7 having a laminated structure of base material/hygroscopic layer/upper layer was prepared in the same manner as in Example 1 except that the moisture-absorbing agent in the hygroscopic layer forming coating liquid in Example 1 was changed from calcium chloride to magnesium sulfate.

### Example 8

A hygroscopic material of Example 8 having a laminated structure of base material/hygroscopic layer/upper layer was prepared in the same manner as in Example 1 except that the ethylene/vinyl acetate copolymer in the upper layer forming coating liquid in Example 1 was changed to an ethylene/vinyl chloride/vinyl acetate copolymer (trade name: SUMIKAFLEX (registered trademark) S-830, concentration of solid contents: 50% by mass, manufactured by manufactured by Sumika Chemtex Co., Ltd.).

### Example 9

A hygroscopic material of Example 9 having a laminated structure of base material/hygroscopic layer/upper layer was prepared in the same manner as in Example 1 except that the solid content of the ethylene/vinyl acetate copolymer in the upper layer forming coating liquid in Example 1 was dissolved in 52.5 parts by mass of toluene, the amount of the polyoxyethylene lauryl ether (surfactant) solution was changed to 0.0 parts by mass, and the amount of ion exchange water was changed to 0.0 parts by mass.

### Example 10

A hygroscopic material of Example 10 having a laminated structure of base material/hygroscopic layer/upper layer was prepared in the same manner as in Example 1 except that the base material and the hygroscopic layer, and the upper layer in Example 1 were melt-laminated according to the same method as in Examples described in JP1995-199405A (JP-H07-199405A).

### Comparative Example 1

A hygroscopic material of Comparative Example 1 having a laminated structure of base material/hygroscopic layer was prepared in the same manner as in Example 1 except that the upper layer was not formed on the surface of the hygroscopic layer formed on the base material in Example 1.

### Comparative Example 2

A hygroscopic material of Comparative Example 2 having a laminated structure of base material/hygroscopic layer/upper layer was prepared in the same manner as in Example 1 except that the ethylene/vinyl acetate copolymer in the upper layer forming coating liquid in Example 1 was changed to an ethylene/vinyl chloride copolymer (trade name: SUMIELITE (registered trademark) SE-1010, concentration of solid contents: 50% by mass, manufactured by manufactured by Sumika Chemtex Co., Ltd.).

### Comparative Example 3

A hygroscopic material of Comparative Example 3 having a laminated structure of base material/hygroscopic layer/upper layer was prepared in the same manner as in Example 1 except that the ethylene/vinyl acetate copolymer in the upper layer forming coating liquid in Example 1 was changed to polyethylene (PE) (trade name: ARROW BASE (registered trademark) SB-1010, concentration of solid contents: 25% by mass, manufactured by Unitika Ltd.) and the amount of ion exchange water was changed to 5.5 parts by mass.

### Comparative Example 4

A hygroscopic material of Comparative Example 4 having a laminated structure of base material/hygroscopic layer/upper layer was prepared in the same manner as in Example 1 except that the ethylene/vinyl acetate copolymer in the upper layer forming coating liquid in Example 1 was changed to polyvinylidene chloride (PVDC) (trade name: SALAN LATEX (registered trademark) L140A, concentration of solid contents: 50% by mass, manufactured by Asahi Kasei Corporation).

### Comparative Example 5

A hygroscopic material of Comparative Example 5 having a laminated structure of base material/hygroscopic layer/upper layer was prepared in the same manner as in Example 1 except that the ethylene/vinyl acetate copolymer in the upper layer forming coating liquid in Example 1 was changed to a styrene/butadiene copolymer (trade name: Nipol (registered trademark) SX1105A, concentration of solid contents: 45% by mass, manufactured by Zeon Corporation), and the amount of ion exchange water was changed to 43.1 parts by mass.

### Comparative Example 6

A hygroscopic material of Comparative Example 6 having a laminated structure of base material/hygroscopic layer/upper layer was prepared in the same manner as in Example 1 except that the ethylene/vinyl acetate copolymer in the upper layer forming coating liquid in Example 1 was changed to an acrylonitrile/butadiene copolymer (trade name: Nipol (registered trademark) SX1503A, concentration of solid contents: 42% by mass, manufactured by Zeon Corporation), and the amount of ion exchange water was changed to 37.5 parts by mass.

### Comparative Example 7

A hygroscopic material of Comparative Example 7 having a laminated structure of base material/hygroscopic layer/upper layer was prepared in the same manner as in Example 1 except that the moisture-absorbing agent was not formulated in the hygroscopic layer forming coating liquid in Example 1.

### Comparative Example 8

A hygroscopic material of Comparative Example 8 having a laminated structure of base material/hygroscopic layer/upper layer was prepared in the same manner as in Example 1 except that the moisture-absorbing agent in the hygroscopic layer forming coating liquid in Example 1 was changed from calcium chloride to zeolite (trade name: MOLECULAR SIEVE, type: 3A, form: powder, manufactured by UNION SHOWA K.K.).

<Evaluation>

Each hygroscopic material of Examples 1 to 10 and Comparative Examples 1 to 8 obtained as described was evaluated as follows. The evaluation results are shown in Table 1.

1. Transparency (Measurement of Total Light Transmittance)

The total light transmittance (unit: %) and the haze (unit: %) of each hygroscopic material of Examples 1 to 10 and Comparative Examples 1 to 8 were measured according to JIS K7361-1:1997 and JIS K7136:2000, respectively. Specifically, the total light transmittance and the haze of the base material were measured in an environment at an atmosphere temperature of 23° C. and a relative humidity of 50% using a haze meter (model number: NDH-5000, manufactured by Nippon Denshoku Industries Co., Ltd.) as a measurement apparatus. Then, the measured values of the total light transmittance and the haze were used as indices for evaluating the transparency. As the value of the total light transmittance increases, or as the value of the haze increases, the hygroscopic material exhibits further excellent transparency.

2. Hygroscopicity (Measurement of Amount of Moisture Absorption)

Each hygroscopic material of Examples 1 to 10 and Comparative Examples 1 to 8 was cut into a size of 100 mm×100 mm to obtain a sample for evaluation. The sample for evaluation was stored in a thermohygrostat bath set at a temperature of 60° C. and a relative humidity of 10% for 1 day and dried. Next, the sample for evaluation after being dried was moved to an environment at a temperature of 23° C. and a relative humidity of 50%, and then the mass thereof immediately after the sample was moved (within 20 seconds) was measured. Then, the obtained measurement value was set to the mass of the sample for evaluation in a dried state. Thereafter, a change in mass of the sample for evaluation along with the lapse of time was measured and the mass at the time when a change in mass does not occur was set to the mass of the sample for evaluation in a saturated state. The amount of moisture absorption of the sample for evaluation (unit: g/m²) was obtained by subtracting the mass in a dried state from the mass in a saturated state.

TABLE 1

| | | | | | | Evaluation | | |
|---|---|---|---|---|---|---|---|---|
| | | | | | | Total | | Amount |
| | | Hygroscopic layer | | | | light | | of |
| | | | Moisture- | | | trans- | | moisture |
| | Base | | absorbing | Upper layer | | mittance | Haze | absorption |
| | material | Resin | agent | Resin | Formation method | (%) | (%) | (g/m²) |
| Example 1 | PET | PVA | Calcium chloride | Ethylene/vinyl acetate copolymer | Water dispersion application | 92.4 | 3.8 | 3.3 |
| Example 2 | PVC | PVA | Calcium chloride | Ethylene/vinyl acetate copolymer | Water dispersion application | 89.4 | 5.5 | 3.2 |
| Example 3 | PVC/ | PVA | Calcium chloride | Ethylene/vinyl acetate copolymer | Water dispersion application | 87.4 | 9.9 | 3.2 |
| | PVDC/ | | | | | | | |
| | PVC | | | | | | | |
| Example 4 | CPP | PVA | Calcium chloride | Ethylene/vinyl acetate copolymer | Water dispersion application | 91.6 | 7.5 | 3.3 |
| Example 5 | PET | PAA | Calcium chloride | Ethylene/vinyl acetate copolymer | Water dispersion application | 92.2 | 6.2 | 3.1 |
| Example 6 | PET | Ethylene/ | Calcium chloride | Ethylene/vinyl acetate copolymer | Water dispersion application | 89.1 | 18.3 | 3.0 |
| | | vinyl | | | | | | |
| | | acetate | | | | | | |
| | | copolymer | | | | | | |
| Example 7 | PET | PVA | Magnesium | Ethylene/vinyl acetate copolymer | Water dispersion application | 87.9 | 24.8 | 2.1 |
| | | | sulfate | | | | | |
| Example 8 | PET | PVA | Calcium chloride | Ethylene/vinyl chloride/vinyl | Water dispersion application | 92.8 | 1.9 | 3.3 |
| | | | | acetate copolymer | | | | |
| Example 9 | PET | PVA | Calcium chloride | Ethylene/vinyl acetate copolymer | Solvent solution application | 92.3 | 3.7 | 3.3 |
| Example 10 | PET | PVA | Calcium chloride | Ethylene/vinyl acetate copolymer | Melt lamination | 92.5 | 3.9 | 3.3 |
| Comparative | PET | PVA | Calcium chloride | Not used | Not used | 90.9 | 31.5 | 3.2 |
| Example 1 | | | | | | | | |
| Comparative | PET | PVA | Calcium chloride | Ethylene/vinyl chloride | Water dispersion application | 90.1 | 43.3 | 3.3 |
| Example 2 | | | | copolymer | | | | |
| Comparative | PET | PVA | Calcium chloride | PE | Water dispersion application | 90.7 | 40.8 | 3.1 |
| Example 3 | | | | | | | | |
| Comparative | PET | PVA | Calcium chloride | PVDC | Water dispersion application | 89.1 | 38.4 | 3.2 |
| Example 4 | | | | | | | | |
| Comparative | PET | PVA | Calcium chloride | Styrene/butadiene copolymer | Water dispersion application | 87.3 | 47.1 | 3.2 |
| Example 5 | | | | | | | | |
| Comparative | PET | PVA | Calcium chloride | Acrylonitrile/butadiene | Water dispersion application | 86.3 | 46.5 | 3.3 |
| Example 6 | | | | copolymer | | | | |
| Comparative | PET | PVA | Not used | Ethylene/vinyl acetate copolymer | Water dispersion application | 92.1 | 3.7 | 0.2 |
| Example 7 | | | | | | | | |
| Comparative | PET | PVA | Zeolite | Ethylene/vinyl acetate copolymer | Water dispersion application | 90.3 | 51.4 | 0.6 |
| Example 8 | | | | | | | | |

As shown in Table 1, the hygroscopic materials of Examples 1 to 10 exhibited excellent results in the evaluation on both hygroscopicity and transparency.

In contrast, the hygroscopic materials of Comparative Examples 1 to 8 exhibited poor results in the evaluation on at least one of hygroscopicity or transparency.

The hygroscopic materials of Examples 1 and 5 in which the hygroscopic layer included a water-soluble resin as the resin exhibited further excellent hygroscopicity and transparency compared to the hygroscopic material of Example 6 in which the hygroscopic layer included a water-insoluble resin as the resin.

The hygroscopic material of Example 1 in which the hygroscopic layer included polyvinyl alcohol (PVA) as the resin exhibited further excellent transparency compared to the hygroscopic material of Example 5 including polyacrylic acid (PAA), which is the same water-soluble resin.

The hygroscopic material of Example 1 in which the hygroscopic layer included calcium chloride as the moisture-absorbing agent exhibited further excellent hygroscopicity and transparency compared to the hygroscopic material of Example 7 including magnesium sulfate, which is the same inorganic salt.

The hygroscopic material of Example 1 in which the upper layer was formed by applying the vinyl acetate resin water dispersion liquid exhibited equal hygroscopicity and transparency but had an excellent surface state compared to the hygroscopic material of Example 9 in which the upper layer was formed by applying the solvent solution and the hygroscopic material of Example 10 in which the upper layer was formed by melt lamination. The reason for obtaining the result is considered that since the hygroscopic layer absorbs water, cissing has occurred in Example 9 and foaming has occurred in Example 10.

The hygroscopic material of Example 8 in which the upper layer included, as the vinyl acetate resin, the ethylene/vinyl chloride/vinyl acetate copolymer, which is the copolymer including at least a constitutional unit derived from a vinyl acetate monomer and a constitutional unit derived from a vinyl chloride monomer, exhibited further excellent transparency compared to the hygroscopic material of Example 1 including the ethylene/vinyl acetate copolymer, which is the same vinyl acetate resin.

The hygroscopic material of Comparative Example 1 not having the upper layer exhibited a low total light transmittance, a high haze, and poor transparency compared to the hygroscopic material of Example 1 having the upper layer including the vinyl acetate resin.

The hygroscopic materials of Comparative Examples 2 to 6 in which the upper layer included resins other than vinyl acetate resin exhibited a low total light transmittance, a high haze, and poor transparency compared to the hygroscopic materials including the vinyl acetate resin (for example, Examples 1, 8, 9, and 10).

The hygroscopic material of Comparative Example 7 in which the hygroscopic layer did not include the moisture-absorbing agent rarely exhibited hygroscopicity.

The hygroscopic material of Comparative Example 8 in which the hygroscopic layer included the moisture-absorbing agent, which is not an inorganic salt, exhibited poor results in the evaluation on both hygroscopicity and transparency compared to the hygroscopic material including the moisture-absorbing agent which is an inorganic salt, (for example, Example 1).

The present application claims priority from Japanese Patent Application No. 2015-094269 filed on May 1, 2015, the content of which is herein incorporated by reference in the entirety.

All the documents, patent applications and technical standards described in the specification are incorporated into the specification for reference to the same extent as cases in which it is specifically and respectively described that the respective documents, patent applications and technical standards are incorporated by reference.

The hygroscopic material of the present disclosure is suitable for a packaging material which requires both hygroscopicity and transparency. For example, the hygroscopic material of the present disclosure is suitably used as a packaging material or a material thereof for packing a pharmaceutical product, an electronic component, or the like, for which a packaging material from which the content is visible is required to be used in terms of quality control, and the cost of failing to remember to put in a drying agent is considerable.

What is claimed is:

1. A hygroscopic material comprising:
a transparent base material;
an upper layer including a vinyl acetate resin; and
a hygroscopic layer which is arranged between the base material and the upper layer to be adjacent to the upper layer and includes a moisture-absorbing agent which is an inorganic salt, and a resin.

2. The hygroscopic material according to claim 1,
wherein a total light transmittance is 85% or more, and a haze is 30% or less.

3. The hygroscopic material according to claim 1,
wherein an amount of moisture absorption is 1 g/m² or more.

4. The hygroscopic material according to claim 1,
wherein the resin included in the hygroscopic layer is a water-soluble resin.

5. The hygroscopic material according to claim 4,
wherein the water-soluble resin is a polyvinyl alcohol resin.

6. The hygroscopic material according to claim 1,
wherein the moisture-absorbing agent is calcium chloride.

7. The hygroscopic material according to claim 1,
wherein the upper layer includes particles of the vinyl acetate resin.

8. The hygroscopic material according to claim 7,
wherein the particles of the vinyl acetate resin have a volume average particle diameter of from 0.01 μm to 10 μm.

9. The hygroscopic material according to claim 1,
wherein the vinyl acetate resin included in the upper layer is a copolymer including at least a constitutional unit derived from a vinyl acetate monomer and a constitutional unit derived from a vinyl chloride monomer.

10. The hygroscopic material according to claim 9,
wherein the copolymer is at least one selected from the group consisting of vinyl chloride/vinyl acetate copolymer and ethylene/vinyl chloride/vinyl acetate copolymer.

11. The hygroscopic material according to claim 1,
wherein the upper layer has a thickness of from 0.1 μm to 10 μm.

12. A packaging material comprising:
the hygroscopic material according to claim 1,

13. A method for producing the hygroscopic material according to claim 1, the method comprising:
an arrangement step of arranging a hygroscopic layer including a moisture-absorbing agent which is an inorganic salt, and a resin, and an upper layer including a vinyl acetate resin on a transparent base material.

14. The method for producing a hygroscopic material according to claim 13,
wherein the arrangement step includes
a hygroscopic layer forming step of forming the hygroscopic layer by applying a hygroscopic layer forming coating liquid including a moisture-absorbing agent which is an inorganic salt, and a resin to the transparent base material, and
an upper layer forming step of forming the upper layer by applying an upper layer forming coating liquid including particles of vinyl acetate resin to the transparent base material.
